(19) United States
(12) Patent Application Publication
(10) Pub. No.: US 2025/0304002 A1
(43) Pub. Date: Oct. 2, 2025

(54) SYSTEM AND METHOD FOR MANAGING CONTROL AUTHORITY OF AUTONOMOUS VEHICLE

(71) Applicants: Hyundai Motor Company, Seoul (KR); Kia Corporation, Seoul (KR)

(72) Inventor: Jun Soo KIM, Seoul (KR)

(73) Assignees: Hyundai Motor Company, Seoul (KR); Kia Corporation, Seoul (KR)

(21) Appl. No.: 18/965,838

(22) Filed: Dec. 2, 2024

(30) Foreign Application Priority Data
Mar. 29, 2024 (KR) 10-2024-0043088

(51) Int. Cl. B60R 25/04; B60L 53/14; B60R 25/01; B60R 25/24; B60W 60/00; G06Q 10/0631; G07C 5/02

(52) U.S. Cl. CPC B60R 25/04; B60R 25/01; B60R 25/24; B60W 60/00; G06Q 10/06311; G07C 5/02; B60L 53/14

(57) ABSTRACT

In a system and method for managing control authority of an autonomous vehicle, the method of managing control authority for an autonomous vehicle may include identifying a schedule of the vehicle during an unused period of the vehicle registered by a manager, determining an available time of the vehicle by a user other than the manager, receiving a request for use of the vehicle within the available time from a user device carried by the user, transmitting the request for use of the vehicle to a manager device carried by the manager, receiving a response from the manager device, and granting the user device a permission to control the vehicle based on the response, wherein the permission to control the vehicle is determined by the identified schedule of the vehicle.

### CROSS-REFERENCE TO RELATED APPLICATIONS

The present application claims priority to Korean Patent Application No. 10-2024-0043088, filed Mar. 29, 2024, the entire contents of which is incorporated herein for all purposes by this reference.

### BACKGROUND OF THE PRESENT DISCLOSURE

### Field of the Present Disclosure

The present disclosure relates to an authority management system for an autonomous vehicle, and more particularly, to a system and a method for managing the permission to control an autonomous vehicle so that a person other than a vehicle owner utilizes the autonomous vehicle.

### Description of Related art

The content described in the present section simply provides background information for the present embodiment and does not form the related art.

An autonomous vehicle refers to a vehicle that can recognize a traveling environment, determine danger, plan a driving route, and travel by itself without an operation of the driver. Levels of automation of such an autonomous vehicle are divided into six levels from level 0 to level 5 according to the guidelines J3016 presented by the Society of Automotive Engineers (SAE).

Meanwhile, in the case of an unmanned autonomous vehicle, since there is no operation of a driver, the unmanned autonomous vehicle must directly generate a driving route or a server must generate the driving route to transfer the driving route. Therefore, the driving route of the autonomous vehicle must be efficiently generated based on entire complex road conditions that are varied in real time.

The autonomous vehicle can provide various services to users. There is a demand for a method of providing a delivery service, a vehicle sharing service, a vehicle hailing service, and the like of the autonomous vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a technology for control authority management for an autonomous vehicle, such as granting or revoking permission to control the autonomous vehicle to or from another person by an owner of the autonomous vehicle, that is, a vehicle owner.

Furthermore, the present disclosure is directed to providing a system and method for managing permission to control an autonomous vehicle configured for increasing a degree of utilization of the autonomous vehicle on a mobility platform using such a technology.

The problems to be solved by the present disclosure are not limited to the above-mentioned problems, and other problems not mentioned will be clearly understood by those skilled in the art from the following description.

According to at least an exemplary embodiment of the present disclosure, the present disclosure provide a method of managing control authority for an autonomous vehicle including identifying a schedule of the vehicle during an unused period of the vehicle registered by a manager, determining an available time of the vehicle by a user other than the manager, receiving a request for use of the vehicle within the available time from a user device carried by the user, transmitting the request for use of the vehicle to a manager device carried by the manager, receiving a response from the manager device, and granting the user device a permission to control the vehicle based on the response, wherein the permission to control the vehicle is determined by the identified schedule of the vehicle.

According to another exemplary embodiment of the present disclosure, the present disclosure provide an apparatus for managing control authority for an autonomous vehicle including a communication unit, and a processor operatively connected to the communication unit and configured to control the communication unit, wherein the processor is configured to identify a schedule of the vehicle during an unused period of the vehicle registered by a manager, determine an available time of the vehicle by a user other than the manager, receive a request for use of the vehicle within the available time from a user device carried by the user through the communication unit, transmit the request for use of the vehicle to a manager device carried by the manager through the communication unit, receive a response from the manager device, and grant the user device a permission to control the vehicle based on the response, wherein the permission to control the vehicle is determined by the identified schedule of the vehicle.

According to another exemplary embodiment of the present disclosure, the present disclosure provide a permission management system for an autonomous vehicle including an apparatus configured to manage control authority for an autonomous vehicle, the apparatus including a communication unit, and a processor operatively connected to the communication unit and configured to control the communication unit; a manager device configured to input a schedule of the vehicle during an unused period of the vehicle to the apparatus after a pre-designated manager with the control authority for the vehicle gets off the vehicle; and a user device configured to transmit a request message for use of the vehicle to the apparatus for use of the vehicle according to the schedule of the vehicle, wherein the processor is configured to identify a schedule of the vehicle during an unused period of the vehicle registered by a manager, determine an available time of the vehicle by a user other than the manager, receive a request for use of the vehicle within the available time from a user device carried by the user through the communication unit, transmit the request for use of the vehicle to a manager device carried by the manager through the communication unit, receive a response from the manager device, and grant the user device a permission to control the vehicle based on the response, wherein the permission to control the vehicle is determined by the identified schedule of the vehicle.

According to an aspect of the present disclosure, it is possible to extend the scope of utilization of the autonomous vehicle by allowing a user other than a vehicle owner to use the vehicle when the vehicle owner does not use the vehicle through control authority management for the autonomous vehicle.

According to another aspect of the present disclosure, the autonomous vehicle can perform a registered schedule (for example, parking, maintenance, and charging) under control authority management by the vehicle owner.

Effects provided by the technologies of the present disclosure are not limited to the above-mentioned effects, and other effects not mentioned will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an illustrative block diagram of a part of an autonomous vehicle to which embodiments of the present disclosure are applied.

FIG. 2 is a block diagram of an apparatus for managing control authority for an autonomous vehicle according to an exemplary embodiment of the present disclosure.

FIG. 3 is a flowchart of a method of managing control authority for an autonomous vehicle according to various exemplary embodiments of the present disclosure.

FIG. 4 is a flowchart of the method of managing control authority for an autonomous vehicle according to various exemplary embodiments of the present disclosure.

FIG. 5 is a flowchart of the method of managing control authority for an autonomous vehicle according to various exemplary embodiments of the present disclosure.

FIG. 6 is a flowchart of the method of managing control authority for an autonomous vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description, like reference numerals designate like elements, although the elements are shown in different drawings. Furthermore, for clarity and for brevity, the following description of various exemplary embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary. The terms such as “unit,” “module,” and the like refer to units in which at least one function or operation is processed and they may be implemented by hardware, software, or a combination thereof.

The description of the present disclosure to be presented below in conjunction with the accompanying drawings is directed to describe exemplary embodiments of the present disclosure and is not intended to represent the only embodiments in which the technical idea of the present disclosure may be practiced.

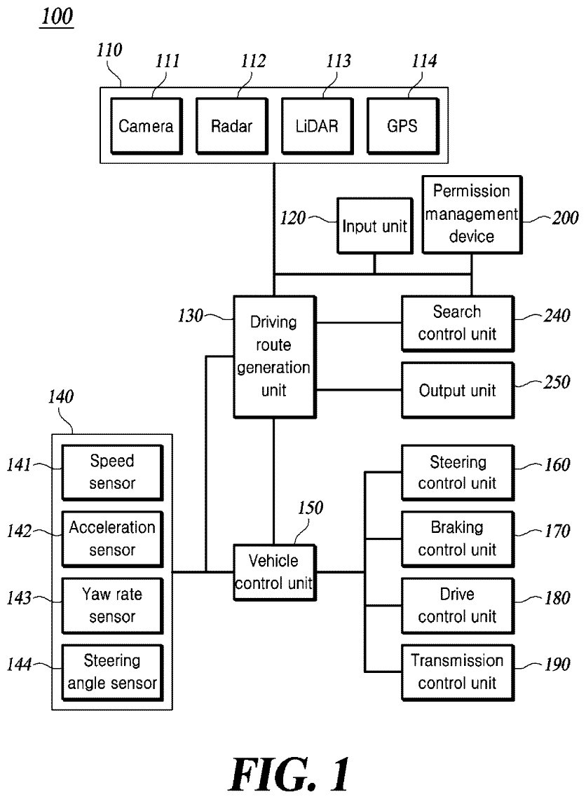

FIG. 1 is an illustrative block diagram of a part of an autonomous vehicle to which embodiments of the present disclosure are applied.

Referring to FIG. 1, an autonomous vehicle 100 to which embodiments of the present disclosure are applied includes, for example, a sensor unit 110, an input unit 120, a driving route generation unit 130, a vehicle sensor unit 140, a vehicle control unit 150, a steering control unit 160, a braking control unit 170, a drive control unit 180, a transmission control unit 190, a permission management device 200, a search control unit 240, and an output unit 250. According to a scheme of implementing embodiments of the present disclosure, respective components may be coupled to each other and provided as a single component, and some of components may be omitted according to a scheme of implementing the present disclosure.

Here, the driving route generation unit 130, the vehicle control unit 150, the steering control unit 160, the braking control unit 170, the drive control unit 180, the transmission control unit 190, the search control unit 240 may include a processor, a memory, and the like. The driving route generation unit 130, the vehicle control unit 150, the steering control unit 160, the braking control unit 170, the drive control unit 180, the transmission control unit 190, and the search control unit 240 may exchange data (information) with each other through a vehicle network such as a Controller Area Network (CAN), a Media Oriented Systems Transport (MOST) network, a Local Interconnect Network (LIN), or an X-by-Wire (Flexray).

The sensor unit 110 obtains environment information around the vehicle. Here, the environment information includes a distance between a host vehicle and a rear vehicle, a relative speed of the rear vehicle, a position of a front vehicle (a preceding vehicle), obstacle and traffic light information, and the like.

The sensor unit 110 may include a camera 111, a radio detection and ranging (RADAR) 112, a Light Detection and Ranging (LiDAR) 113, and a global positioning system (GPS) 114. Here, the camera 111 may include an infrared camera, a stereo camera, or a 3D camera, and the LiDAR 113 may include a 2D LiDAR and a 3D LiDAR. Furthermore, the sensor unit 110 detects images around the vehicle, the distance between the host vehicle and the rear vehicle, the relative speed of the rear vehicle, the front vehicle, the obstacle, and/or the traffic light through the camera 111, the radio detection and ranging (RADAR) 112, and the LiDAR 113, and detects a current position of the host vehicle through the Global Positioning System (GPS) 114. Also, the sensor unit 110 may further include an ultrasonic sensor.

The input unit 120 generates data input by a user. For example, the input unit 120 generates information on a schedule of the vehicle including destination information (for example, a place name and/or coordinates), a usage time, and a mission according to a user's input. The input unit 120 may include a keypad, a dome switch, a touchpad, a voice recognizer, a jog wheel, and/or a jog switch.

The vehicle sensor unit 140 measures vehicle information for the host vehicle. The vehicle information includes a speed, acceleration, a yaw rate, a steering angle, and the like of the host vehicle. The vehicle sensor unit 140 may include a speed sensor 141, an acceleration sensor 142, a yaw rate sensor 143, a steering angle sensor 144, and the like

The driving route generation unit 130 generates a driving route (a global route) for autonomous driving of the vehicle. When a destination is input through the input unit 120, the driving route generation unit 130 generates a driving route from the current position of the host vehicle to the destination. In the instant case, the driving route generation unit 130 generates the driving route based on a precise map and/or real-time traffic information obtained through wireless communication. The precise map and/or real-time traffic information may be provided by map service providers, Intelligent Transportation Systems (ITS), autonomous vehicle manufacturers, carriers, and other relevant entities. Wireless Internet, mobile communication, or broadcasting communication may be used as a wireless communication technology.

The driving route generation unit 130 generates a driving route to a place where a caller who has called the autonomous vehicle is located. When an autonomous parking instruction is input through the input unit 120, the driving route generation unit 130 generates a route from the current position to a parking available area.

The output unit 250 outputs visual information, auditory information, tactile information, and/or the like, and may include a display, an audio output module, a haptic module, and the like. For example, the output unit 250 superimposes and displays the driving route output from the driving route generation unit 130 on the precise map.

The output unit 250 may output a warning message, a notification message, or the like as an audio signal under the control of the driving route generation unit 130.

Furthermore, the output unit 250 may further include a display and an electronic display board mounted on the outside of the autonomous vehicle to display information (for example, photo, phone number, ID, unique number, and single-use code) on the caller so that the caller can more easily recognize the autonomous vehicle.

The vehicle control unit 150 is configured to control autonomous driving of the vehicle according to the driving route generated by the driving route generation unit 130. The vehicle control unit 150 obtains the vehicle information from the vehicle sensor unit 140 and is configured to perform vehicle control based on the obtained vehicle information.

Furthermore, the vehicle control unit 150 is configured to control the autonomous driving of the vehicle up to a place where the caller who has called the autonomous vehicle is located and/or from the current position to the parking available area.

The steering control unit 160 is configured to control the steering of the vehicle, and is implemented as motor drive power steering (MDPS). The steering control unit 160 is configured to control a steering angle of the vehicle according to the control of the vehicle control unit 150.

The braking control unit 170 is directed to control a speed of the vehicle, and is implemented as an electronic stability control (ESC). The braking control unit 170 is configured to control a braking pressure according to a position of a brake pedal or is configured to control the braking pressure according to the control of the vehicle control unit 150.

The drive control unit 180 is a device that is configured to control an engine of the vehicle, and is configured to control acceleration and deceleration of the vehicle. The drive control unit 180 is implemented as an engine management system (EMS). The drive control unit 180 is configured to control a driving torque of the engine according to accelerator pedal position information. Furthermore, the drive control unit 180 is configured to control an engine output to follow a target driving torque requested from the vehicle control unit 150.

The transmission control unit 190 is configured to shift a gear (shifting stage) of the vehicle. The transmission control unit 190 may be implemented as an electronic shifter or an electric shifter (Shift By Wire; SBW).

The search control unit 240 captures at least one image of surroundings of a stop/parking available area through the camera 111 to search for the surroundings of the stop/parking available area according to get-off of the driver and a pickup instruction of the driver, and perceives danger. Furthermore, the search control unit 240 identifies whether or not the vehicle enters a parking lot, performs switching from an autonomous driving mode to an autonomous parking mode, and generates a parking route while interworking with the driving route generation unit 130. Furthermore, when the use of the vehicle is permitted to a person other than a designated manager and the vehicle approaches a place where the user is located, the search control unit 240 searches for and identifies the permitted user using the sensor unit 110. Here, the designated manager may refer to at least one of a vehicle owner or a designated driver. In the instant case, the search control unit 240 may use pattern matching, face recognition, and the like.

The search control unit 240 interworks with the permission management device 200 of the vehicle to be described later so that an authorized user other than the designated manager can authenticate for the use of the vehicle and access the vehicle.

The autonomous vehicle is a vehicle that can recognize a traveling environment, determine danger, plan a driving route, and travel by itself without an operation of the driver, and may be provided for access and use of an unspecified number of people through a mobility platform such as vehicle sharing or vehicle hailing. In the instant case, an authority management technology for transferring and recovering the control authority for the vehicle is essentially required to safely guarantee the security of the vehicle while extending a mobility service of the autonomous vehicle, or the like even in the absence of the designated manager (for example, a vehicle owner).

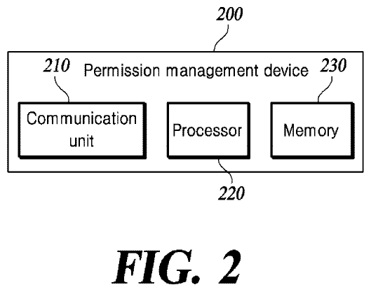

FIG. 2 is a block diagram of an apparatus for managing control authority for an autonomous vehicle according to an exemplary embodiment of the present disclosure.

Referring to FIG. 2, the permission management device 200 of the autonomous vehicle according to an exemplary embodiment of the present disclosure includes a communication unit 210, a processor 220, and a memory 230. The permission management device 200 may be implemented inside or outside the vehicle. In the instant case, the permission management device 200 may be integrally formed with internal control units of the vehicle, or may be implemented as a separate hardware device and connected to the control units of the vehicle by a connection means.

The communication unit 210 may be included in the autonomous vehicle 100 and may receive a schedule to be performed by the vehicle, a call, a call position, and destination information of the vehicle in the absence of the manager from a designated manager device of the vehicle 100. Furthermore, the communication unit 210 may receive a call, a call position, and user information from a user device requesting use of the vehicle 100. The user device can be a smartphone, tablet computer, notebook computer or any other device that can be wirelessly coupled to the autonomous vehicle and/or the server. For example, the communication unit 210 may receive the call, the call position, and the user information input through the manager or the user device from an external server.

For example, the communication unit 210 may communicate with the external server, the manager device or the user device via a Wireless LAN (WLAN), Wireless-Fidelity (Wi-Fi), Wireless Fidelity (Wi-Fi) Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), or the like.

The manager may use the manager device or the input unit 120 of the vehicle to register a mission to be performed by the autonomous vehicle in the absence of the manager, that is, a schedule of the vehicle. The manager device can be a smartphone, tablet computer, notebook computer or any other device that can be wirelessly coupled to the autonomous vehicle and/or the server. The manager may input at least one of a call request, a call position, and a destination for the autonomous vehicle through the manager device to call the autonomous vehicle.

The user may input at least one of the call request, the call position, the destination, and the user information for the autonomous vehicle through the user device to call the autonomous vehicle. At least one of the call request, the call position, the destination, and the user information input by the user may be transmitted to the server through the user device.

The communication unit 210 may receive, from the server, at least one of the schedule of the vehicle, the call request, the call position, and the destination input by the manager. The communication unit 210 may receive at least one of the call request, the call position, the destination, and the user information input by the user.

The communication unit 210 is configured to enable additional short-range communication and may communicate with a peripheral terminal of the autonomous vehicle 100. For example, the communication unit 210 may communicate with the peripheral terminal of the autonomous vehicle through Bluetooth or low power Bluetooth. For example, the communication unit 210 may communicate with a peripheral terminal present within a specific distance from the autonomous vehicle.

The processor 220 is configured to control the communication unit 210 and to perform entire control so that the permission management device 200 can normally perform all functions. The processor 220 may be implemented in a form of hardware, software, or a combination of hardware and software. The processor 220 may be implemented as a microprocessor, but is not limited thereto. Furthermore, the processor 220 may perform various types of data processing, determination, and the like using the information stored in the memory 230. In one example, the processor 220 may be configured to execute a series of instructions stored in the memory 230.

The processor 220 may identify the schedule of the vehicle during the unused period of the vehicle by the designated manager. The schedule of the vehicle corresponds to a mission that the autonomous vehicle may perform by itself in the absence of the manager. The schedule of the vehicle may be limited to a preset one, for example. As an exemplary embodiment of the present disclosure, the schedule of the vehicle may include parking, charging, maintenance, and call service provision. The schedule of the vehicle is not limited to the example, and may continue to be further extended.

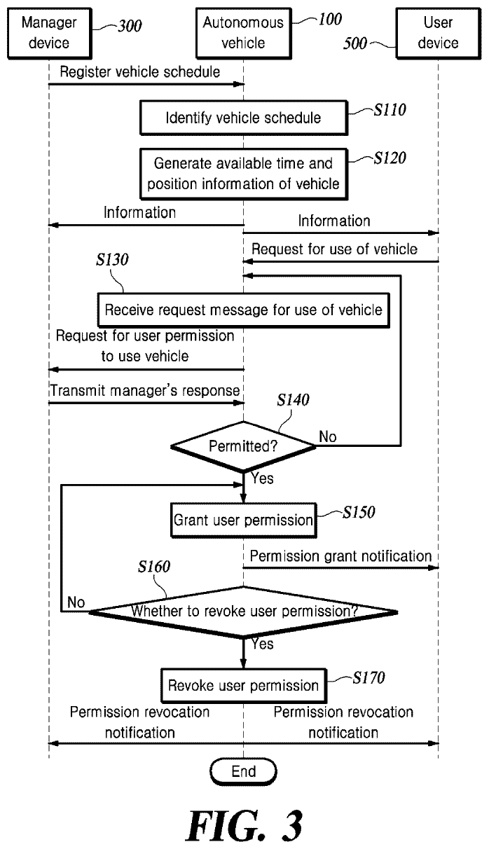

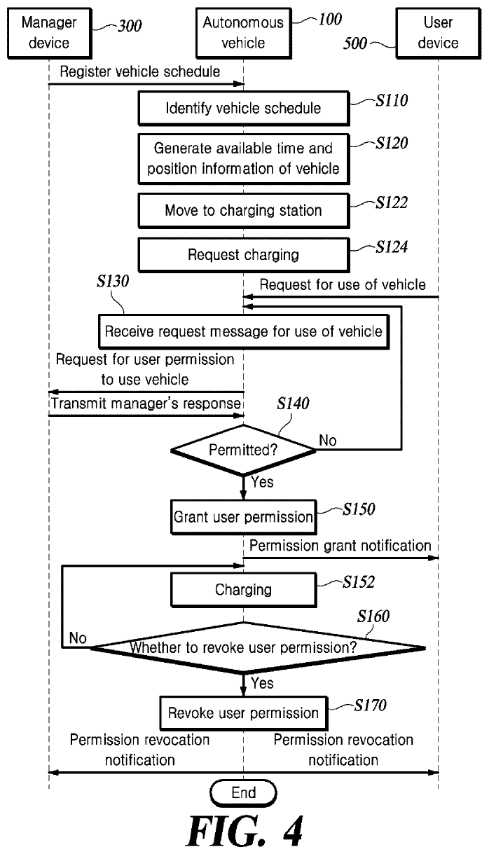

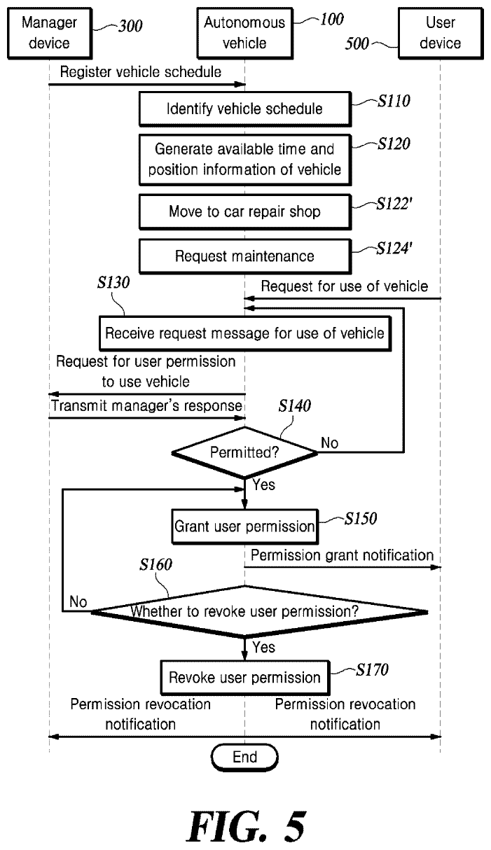

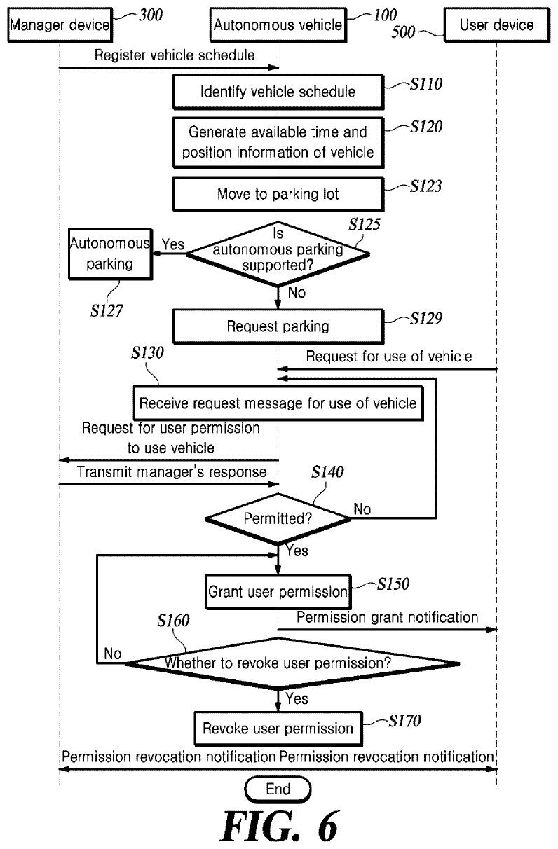

More detailed description of a function of the processor 220 will be described later with reference to FIG. 3, FIG. 4, FIG. 5 and FIG. 6.

FIG. 3 is a flowchart of a method of managing control authority for an autonomous vehicle according to various exemplary embodiments of the present disclosure. The various exemplary embodiments shows a method of managing control authority of a vehicle according to a user's call when the schedule of the autonomous vehicle after the manager gets off is registered as call service provision.

Referring to FIG. 3, the method of managing the control authority for an autonomous vehicle according to the various exemplary embodiments of the present disclosure may be performed by a system for managing the control authority for the autonomous vehicle including the autonomous vehicle 100, a manager device 300, and a user device 500. In the instant case, the autonomous vehicle 100, the manager device 300, and the user device 500 may be connected to a server that provides a call service through a wireless communication network.

The method of managing control authority for an autonomous vehicle according to the exemplary embodiment includes a step S110 of identifying the schedule of the vehicle during the unused period of the vehicle by the designated manager, a step S120 of determining an available time in which a user other than the manager may use the vehicle, a step S130 of receiving a request message for use of the vehicle within the available time from a user device, a step S140 of transmitting a request message for use of the vehicle by the user to the manager device and receiving a response on whether the manager allows the user to use the vehicle, a step S150 of granting user permission to control the vehicle, and steps S160 and S170 of revoking permission to control the vehicle. The respective steps of the exemplary embodiment are performed by a configuration of the autonomous vehicle 100, and it may be said that the steps are performed by the permission management device 200 of the autonomous vehicle, and more specifically, by the processor 220 in the permission management device 200.

In step S110, the processor 220 identifies the schedule of the vehicle during the unused period of the vehicle by the designated manager. The schedule of the vehicle is input through the manager device or through the input unit 120 of the vehicle before step S110, received by the communication unit 210, and transferred to the processor 220. Step S110 may be performed after get-off of the manager is recognized or when the vehicle enters the autonomous parking mode.

In step S120, the processor 220 is configured to determine a time at which the schedule of the vehicle identified in step S110 may be performed, that is, the available time in which a user other than the manager may use the vehicle. The processor 220 may be configured to determine the available time based on a travel time to a pickup place for reuse of the manager. In step S120, the processor 220 may further generate position information of the vehicle.

In an exemplary embodiment of the present disclosure, when the schedule of the vehicle is identified as the call service provision in step S110, a step of announcing the available time of the vehicle by the user and the position information of the vehicle determined or generated in step S120 via the wireless communication network may be further included.

A user who wants to use the vehicle after viewing the announcement may send a request message for use of the vehicle to the autonomous vehicle 100 through the user device 500. The request message for use of the vehicle may include information on the use of the vehicle, that is, a purpose of the use, a use schedule, a current position of the user, a destination, and the like. In the instant case, the user belongs to a user pool previously registered for the use of the vehicle, and thus information on the user may be previously stored in the memory 230. Alternatively, the user is an unspecified person who can send the request message for use of the vehicle with authority to access the network, and the user information may not be stored in the memory 230.

In step S130, the autonomous vehicle 100 receives the request message for use of the vehicle from the user device 500. Furthermore, the autonomous vehicle 100 inquires of the manager device 300 about whether the manager allows the user to use the vehicle based on the received message. The manager transmits a response to the request for use of the vehicle 100 through the manager device 300.

In step S140, the processor 220 identifies whether the manager's response transmitted through the manager device 300 is permission or non-permission. When the manager's response is the permission, the processor 220 is configured to perform step S150 of granting user permission to control the vehicle. When the manager's response is the non-permission, the processor 220 waits for a request for use of the vehicle from another user.

In step S150, the processor 220 grant the user permission to control the vehicle, and the processor 220 may interwork with other components of the vehicle 100 so that the vehicle 100 moves to the current position of the user received in step S130 through autonomous driving. Furthermore, the processor 220 may provide a permission grant notification to the user device.

For example, in step S150, the processor 220 may grant permission to control the vehicle to the user device 500 through a smart key system (SMK) of the autonomous vehicle to grant the user permission to control the vehicle. Here, the smart key system may refer to a system that allows a user carrying a smart key to input vehicle control command including lock or unlock of a door, opening or closing of a trunk, or startup by recognizing the user carrying the smart key through low frequency (LF) or radio frequency (RF) communication. For example, the smart key may be implemented in a form of an application in a terminal of the user.

For example, the permission to control the vehicle may include at least one of a lock of a door of the autonomous vehicle 100, unlock of a door, output of an alarm, control of a navigation, control of a temperature inside the vehicle, or playback of music through the user device.

For example, the user may input a command for at least one of the lock of the door of the autonomous vehicle, the unlock of the door, the output of the alarm, the control of the navigation, the control of the temperature inside the vehicle, or the playback of the music through the user device, and the user device may transmit a command to be received by the autonomous vehicle.

Furthermore, the processor 220 may be configured for controlling the autonomous vehicle based on the command for at least one of the lock of the door of the autonomous vehicle, the unlock of the door, the output of the alarm, the control of the navigation, the control of the temperature inside the vehicle, or the playback of the music received by the autonomous vehicle.

For example, when the door of the autonomous vehicle is unlocked through the user device and then the door is locked again, the processor 220 may start autonomous driving of the autonomous vehicle to the destination.

For example, when the door unlock of the autonomous vehicle is input through the user device to which the permission to control the vehicle has been granted and then the door lock is input again, the processor 220 may be configured to determine that the user has completed boarding the autonomous vehicle and start autonomous driving of the autonomous vehicle toward the destination.

After step S150, the processor 220 may be configured to generate information on the user's vehicle usage in relation to the schedule of the vehicle to be performed, and may transmit information on the user's vehicle usage to the manager device 300. In an exemplary embodiment of the present disclosure, the processor 220 may be configured to generate information on the user's vehicle usage including a movement position of the vehicle, fuel information of the vehicle, get-off of the user, and the like, and transmit the information to the manager device 300.

In step S160, the processor 220 may be configured to determine whether to revoke the permission to control the vehicle granted to the user. When the processor 220 determine that a schedule of provision of the call service has ended by recognizing the get-off of the user after the user arrives at the destination, the processor 220 may be configured to determine the revocation of the permission to control the vehicle granted to the user. When the autonomous vehicle 100 receives the request message for terminating use of the vehicle from the user device 500, the processor 220 may be configured to determine the revocation of the permission to control the vehicle granted to the user.

When the processor 220 is configured to determine the revocation of the permission to control the vehicle in step S160, the processor 220 may revoke the permission to control the vehicle granted to the user through the user device in step S170. Furthermore, if the schedule has not ended in step S160 and the processor 220 is configured to determine not to revoke the permission to control the vehicle, the processor 220 may continue to maintain permission to control the vehicle for the user.

In step S170, when the processor 220 revokes the permission to control the vehicle granted to the user through the user device, the processor 220 may be set to notify the user device and the manager device of the permission revocation.

FIG. 4 is a flowchart of the method of managing control authority for an autonomous vehicle according to various exemplary embodiments of the present disclosure. The various exemplary embodiments shows a method of managing control authority of a vehicle for a user due to charging requiring human intervention when the schedule of the autonomous vehicle is input as charging after the manager gets off. Description of the same portions of the various exemplary embodiments as those of the various exemplary embodiments will be omitted and different portions will be mainly described.

Referring to FIG. 4, the method of managing control authority for an autonomous vehicle according to the various exemplary embodiments further include a step S122 of moving to a charging station, a step S124 of requesting charging, and a step S152 of charging.

When the processor 220 identifies that the schedule of the vehicle is charging in step S110, the autonomous vehicle 100 may autonomously move to the charging station to perform charging (step S122).

In step S124, the processor 220 requests a person in charge of the charging station to perform charging at the charging station at which the autonomous vehicle 100 arrives. In the instant case, when automatic charging that does not require human intervention is possible at the charging station at which the autonomous vehicle 100 arrives, the processor 220 may request a charging station system (for example, an automatic charging robot for an electric vehicle) to perform the charging. Here, the person in charge of the charging station and the charging station system are collectively referred to as a user. For example, the vehicle 100 may request charging through the user device 500.

The user who has received the charging request may send a request message for use of the vehicle to the autonomous vehicle 100 through the user device 500. The processor 220 is configured to perform steps S130 to S170 according to the request message for use of the vehicle from the user.

Content of the permission to control the vehicle granted in step S150 of the various exemplary embodiments of the present disclosure may be limited to the use of the vehicle related to charging, unlike content of the permission to control the vehicle in the various exemplary embodiments requiring driving of the vehicle. For example, the permission to control the vehicle may include at least one of lock of a charging port of the autonomous vehicle 100, unlock of the charging port, control of vehicle startup, or payment of a charging fee.

In the various exemplary embodiments of the present disclosure, the processor 220 may be configured to generate information on the user's vehicle usage including a position of the vehicle, information on a degree of charging of the vehicle, images of the vehicle, and the like, and transmit the information on the user's vehicle usage to the manager device 300.

When the vehicle is charged in step S152 and the processor 220 identifies the completion of charging and determines that a charging schedule ends in step S160, the processor 220 may be configured to determine the revocation of the permission to control the vehicle granted to the user.

FIG. 5 is a flowchart of the method of managing control authority for an autonomous vehicle according to various exemplary embodiments of the present disclosure. The various exemplary embodiments shows a method of managing control authority of a vehicle for a user due to a maintenance work when the schedule of the autonomous vehicle is input as maintenance after the manager gets off. Description of the same portions of the various exemplary embodiments as those of the various exemplary embodiments will be omitted and different portions will be mainly described.

Referring to FIG. 5, the method of managing control authority for an autonomous vehicle according to the various exemplary embodiments further include a step S122′ of moving to a vehicle repair shop, and a step S124′ of requesting maintenance.

When the processor 220 identifies that the schedule of the vehicle is maintenance in step S110, the autonomous vehicle 100 may autonomously move to the vehicle repair shop to perform maintenance (step S122′).

The processor 220 requests a mechanic (hereinafter, referred to as a user) to perform maintenance (step S124′). In step S124′, the vehicle 100 may request the user to perform maintenance through a display mounted on an external surface of the vehicle or the user device.

The user who has received the maintenance request may send a request message for use of the vehicle to the autonomous vehicle 100 through the user device 500. The processor 220 is configured to perform steps S130 to S170 according to the request message for use of the vehicle from the user.

Content of the permission to control the vehicle granted in step S150 of the various exemplary embodiments of the present disclosure may be limited to the use of the vehicle related to maintenance, unlike content of the permission to control the vehicle in the various exemplary embodiments requiring driving of the vehicle. For example, the permission to control the vehicle may include at least one of lock of a door of the autonomous vehicle 100, unlock of the door, lock of a hood, unlock of the hood, lock of a trunk, unlock of the trunk, control of vehicle startup, and payment of a maintenance fee.

In the various exemplary embodiments of the present disclosure, the processor 220 may be configured to generate information on the user's vehicle usage including a maintenance portion of the vehicle, a maintenance portion state of the vehicle, a degree of completion of the maintenance of the vehicle, and the like, and transmit the information on the user's vehicle usage to the manager device 300.

In step S160, when the processor 220 identifies the completion of the maintenance and is configured to determine that the maintenance schedule ends, the processor 220 determine the revocation of the permission to control the vehicle granted to the user.

FIG. 6 is a flowchart of the method of managing control authority for an autonomous vehicle according to various exemplary embodiments of the present disclosure. The various exemplary embodiments shows a method of managing control authority of a vehicle for a user due to parking requiring human intervention when the schedule of the autonomous vehicle is input as parking after the manager gets off. Description of the same portions of the various exemplary embodiments as those of the various exemplary embodiments will be omitted and different portions will be mainly described.

Referring to FIG. 6, the method of managing the control authority for the autonomous vehicle according to the various exemplary embodiments further include a step S123 of moving to a parking lot, a step S125 of determining whether autonomous parking is possible, a step S129 of requesting parking, and an autonomous parking step S127.

When the processor 220 identifies that the schedule of the vehicle is parking in step S110, the autonomous vehicle 100 may autonomously move to the parking lot to perform parking (step S123).

In step S125, the processor 220 is configured to determine whether autonomous parking that does not require human intervention is possible at the parking lot at which the autonomous vehicle 100 has arrived. When the processor 220 determines that the autonomous parking is possible in step S125, the processor 220 interworks with the vehicle control unit 150 so that the vehicle is switched from the driving mode to the autonomous parking mode, and the autonomous vehicle 100 is autonomously parked (step S127). When the parking is completed in step S127, the processor 220 skips performing management of the control authority for the autonomous vehicle.

When the processor 220 determines that the autonomous parking is not possible in step S125, the processor 220 requests a parking attendant (hereinafter, referred to as a user) for valet parking or the like to perform the parking (step S129). In step S129, the vehicle 100 may request the user to perform parking through a display mounted on the external surface of the vehicle or may request the parking through the user device.

The user who has received the parking request may send a request message for use of the vehicle to the autonomous vehicle 100 through the user device 500. The processor 220 is configured to perform steps S130 to S170 according to the request message for use of the vehicle from the user.

Content of the permission to control the vehicle granted in step S150 of the various exemplary embodiments of the present disclosure may be limited to the use of the vehicle related to parking, unlike the content of the permission to control the vehicle in the various exemplary embodiments requiring driving of the vehicle. For example, the permission to control the vehicle may include at least one of lock of a door, unlock of the door, control of vehicle startup, payment of a valet fee, and payment of a parking fee.

In the various exemplary embodiments of the present disclosure, the processor 220 may be configured to generate information on the user's vehicle usage including a parking position of the vehicle, images of the vehicle or surroundings thereof, and the like and transmit the information on the user's vehicle usage to the manager device 300.

When the processor 220 identifies the completion of the parking and determines that the parking schedule ends in step S160, the processor 220 may be configured to determine the revocation of the permission to control the vehicle granted to the user.

The exemplary embodiments of the present disclosure may be summarized as follows.

The method of managing the control authority for an autonomous vehicle according to various exemplary embodiments of the present disclosure may further include generating information on the user's vehicle usage while the permission to control the vehicle is granted to the user.

The method of managing the control authority for an autonomous vehicle according to various exemplary embodiments of the present disclosure may further include revoking the permission to control the vehicle granted to the user.

In the exemplary embodiments of the present disclosure, the schedule of the vehicle includes parking, charging, maintenance, and call service provision.

The method of managing the control authority for an autonomous vehicle according to various exemplary embodiments of the present disclosure may further include announcing the available time of the vehicle by the user other than the manager and the position of the vehicle via the wireless communication network when the schedule of the vehicle is the call service provision.

The apparatus or method according to an exemplary embodiment of the present disclosure may include the respective components provided to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) include instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts are described to be sequentially performed, they merely instantiate the technical idea of various exemplary embodiments of the present disclosure. Therefore, a person having ordinary skill in the pertinent art could perform the steps by changing the sequences described in the respective flowcharts or by performing two or more of the steps in parallel, and hence the steps in the respective flowcharts are not limited to the illustrated chronological sequences.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of managing control authority for an autonomous vehicle, the method comprising:
identifying, by a processor, a schedule of the vehicle during an unused period of the vehicle registered by a manager;
determining, by the processor, an available time of the vehicle by a user other than the manager;
receiving, by the processor, a request for use of the vehicle within the available time from a user device carried by the user;
transmitting, by the processor, the request for use of the vehicle to a manager device carried by the manager;
receiving, by the processor, a response from the manager device; and
granting, by the processor, the user device a permission to control the vehicle based on the response,
wherein the permission to control the vehicle is determined by the identified schedule of the vehicle.

2. The method of claim 1, further including:
generating, by the processor, information on vehicle usage of the user in response that the response from the manager device is to authorize the request for use of the vehicle.

3. The method of claim 1, further including:
determining, by the processor, whether to revoke the permission to control the vehicle granted to the user; and
in response to the determining to revoke, revoking, by the processor, the permission to control the vehicle granted to the user.

4. The method of claim 1, wherein the schedule of the vehicle includes at least one of parking, charging, maintenance, or call service provision of the vehicle.

5. The method of claim 4, further including:
announcing, by the processor, the available time of the vehicle and a position of the vehicle via a wireless communication network in response that the schedule of the vehicle is the call service provision.

6. The method of claim 4, wherein, in response that the schedule of the vehicle is the call service provision, the permission to control the vehicle includes at least one of locking a door of the vehicle, unlocking the door, outputting an alarm, controlling a navigation of the vehicle, controlling a temperature inside the vehicle, or playback of music.

7. The method of claim 4, wherein, in response that the schedule of the vehicle is the charging, the permission to control the vehicle includes at least one of locking a charging port, unlocking the charging port, controlling vehicle startup, or payment of a charging fee.

8. The method of claim 4, wherein, in response that the schedule of the vehicle is the maintenance, the permission to control the vehicle includes at least one of locking a door, unlocking the door, locking a hood, unlocking the hood, locking a trunk, unlocking the trunk, controlling vehicle startup, or payment of a maintenance fee.

9. The method of claim 4, wherein, in response that the schedule of the vehicle is the parking, the permission to control the vehicle includes at least one of locking a door, unlocking the door, controlling vehicle startup, payment of a valet fee, and payment of a parking fee.

10. An apparatus for managing control authority for an autonomous vehicle, the apparatus comprising:
a communication unit; and
a processor operatively connected to the communication unit and configured to control the communication unit, wherein the processor is configured to:
identify a schedule of the vehicle during an unused period of the vehicle registered by a manager,
determine an available time of the vehicle by a user other than the manager,
receive a request for use of the vehicle within the available time from a user device carried by the user through the communication unit,
transmit the request for use of the vehicle to a manager device carried by the manager through the communication unit,
receive a response from the manager device, and
grant the user device a permission to control the vehicle based on the response,
wherein the permission to control the vehicle is determined by the identified schedule of the vehicle.

11. The apparatus of claim 10, wherein the processor is further configured to generate information on vehicle usage of the user in response that the response from the manager device is to authorize the request for use of the vehicle.

12. The apparatus of claim 10, wherein the processor is further configured to determine whether to revoke the permission to control the vehicle granted to the user, and revoke the permission to control the vehicle granted to the user in response to the determining to revoke.

13. The apparatus of claim 10, wherein the schedule of the vehicle includes at least one of parking, charging, maintenance, or call service provision of the vehicle.

14. The apparatus of claim 13, wherein the processor is further configured to announce the available time of the vehicle and a position of the vehicle via a wireless communication network in response that the schedule of the vehicle is the call service provision.

15. The apparatus of claim 13, wherein, in response that the schedule of the vehicle is the call service provision, the permission to control the vehicle includes at least one of locking a door of the vehicle, unlocking the door, outputting an alarm, controlling a navigation of the vehicle, controlling a temperature inside the vehicle, or playback of music.

16. The apparatus of claim 13, wherein, in response that the schedule of the vehicle is the charging, the permission to control the vehicle includes at least one of locking a charging port, unlocking the charging port, controlling vehicle startup, or payment of a charging fee.

17. The apparatus of claim 13, wherein, in response that the schedule of the vehicle is the maintenance, the permission to control the vehicle includes at least one of locking a door, unlocking the door, locking a hood, unlocking the hood, locking a trunk, unlocking the trunk, controlling vehicle startup, or payment of a maintenance fee.

18. The apparatus of claim 13, wherein, in response that the schedule of the vehicle is the parking, the permission to control the vehicle includes at least one of locking a door, unlocking the door, controlling vehicle startup, payment of a valet fee, and payment of a parking fee.

19. A permission management system for an autonomous vehicle, the permission management system comprising:
an apparatus configured to manage control authority for the autonomous vehicle, the apparatus including a communication unit, and a processor operatively connected to the communication unit and configured to control the communication unit;
a manager device configured to input a schedule of the vehicle during an unused period of the vehicle to the apparatus after a pre-designated manager with the control authority for the vehicle gets off the vehicle; and
a user device configured to transmit a request message for use of the vehicle to the apparatus for use of the vehicle according to the schedule of the vehicle,
wherein the processor is configured to:
identify a schedule of the vehicle during an unused period of the vehicle registered by the manager,
determine an available time of the vehicle by a user other than the manager,
receive a request for use of the vehicle within the available time from a user device carried by the user through the communication unit,
transmit the request for use of the vehicle to a manager device carried by the manager through the communication unit,
receive a response from the manager device, and
grant the user device a permission to control the vehicle based on the response, and
wherein the permission to control the vehicle is determined by the identified schedule of the vehicle.

20. The permission management system of claim 19, wherein the processor is further configured to generate information on vehicle usage of the user in response that the response from the manager device is to authorize the request for use of the vehicle.
